(19) United States
(12) Patent Application Publication
(10) Pub. No.: US 2003/0030338 A1
(43) Pub. Date: Feb. 13, 2003

(54) Belt driven electro-mechanical actuator

(76) Inventors: Eric Beishline, Marlborough, MA (US); Macram Bishai, (US)

Correspondence Address: Grossman, Tucker, Perreault & Pfleger, PLLC, Suite 604, 795 Elm Street, Manchester, NH, 03101, US

(21) Appl. No.: 10/099,910

(22) Filed: Mar. 15, 2002

Related U.S. Application Data
(60) Provisional application No. 60/275,991, filed on Mar. 15, 2001.

(51) Int. Cl. H02K 7/10

(52) U.S. Cl. 310/75 R

(57) ABSTRACT

An electromechanical actuator including a motor for driving an actuator output shaft through a gear train and a drive belt for coupling torque from the motor to the gear train. In one embodiment, elastomeric motor supports are provided between the motor and an actuator housing.

### CROSS-REFERENCE TO RELATED APPLICATIONS

The present application claims the benefit of U.S. provisional application serial No. 60/275,991 filed Mar. 15, 2001, the teachings of which are incorporated herein by reference.

### FIELD OF THE INVENTION

The present invention relates generally to electromechanical actuators, and, in particular, to an actuator assembly including a belt-driven gear train.

### BACKGROUND OF THE INVENTION

Electro-mechanical actuators are commonly used for a wide variety of applications. In an automotive setting, for example, actuators may be used for raising and lowering windows, for opening and closing sunroofs, controlling windshield wipers, controlling adjustable pedal systems, etc. Conventionally, electromechanical actuators include an electric motor having a drive shaft for driving a gear train. An output gear on the gear train includes an output shaft for causing rotational or linear motion in the assembly to be driven. The gear train driven by the electric motor may be provided in a variety of configurations. The gear train may include, for example, spur gears, worm gear, helical gears, and/or combinations thereof.

One undesirable feature of conventional electromechanical actuators, especially in automotive applications, is the audible noise generated by their operation. Typically, these actuators run at high load and high mesh frequencies, resulting in significant audible noise. Such audible noise may reach unpleasant levels. In addition, vibration associated with operation of the actuator can result in repetitive impact of actuator components against the actuator housing and/or impact of the housing against the assembly in which the actuator is installed. This repetitive motion can cause wear on actuator components, which over time may result in actuator failure.

There is, therefore, a need in the art for an electromechanical actuator configuration that avoids the deficiencies of the prior art with respect to noise generation, yet also maintains high efficiency operation.

### SUMMARY OF THE INVENTION

An electromechanical actuator consistent with the invention includes: a motor for driving an actuator output shaft through a gear train; and a drive belt for coupling torque from the motor to the gear train. In one embodiment, an actuator consistent with the invention may include: a housing; a motor disposed in the housing for driving an output shaft through a gear train; at least one elastomeric motor support disposed between the motor and the housing; a first belt gear coupled directly to an output shaft of the motor; and an elastomeric drive belt extending between the first belt gear and a second belt gear. The second belt gear may be coupled to the gear train.

A method of dampening motor vibration and noise in an electromechanical actuator consistent with the invention includes: providing a drive belt for transferring torque from the motor to a gear train coupled to an output shaft of the actuator; and providing at least one elastomeric motor support between the motor and a housing of the actuator.

### BRIEF DESCRIPTION OF THE DRAWING

For a better understanding of the present invention, together with other objects, features and advantages, reference should be made to the following detailed description which should be read in conjunction with the following figures wherein like numerals represent like parts:

FIG. 1 is a perspective view an exemplary actuator consistent with the present invention with a top housing cover portion removed.

### DETAILED DESCRIPTION

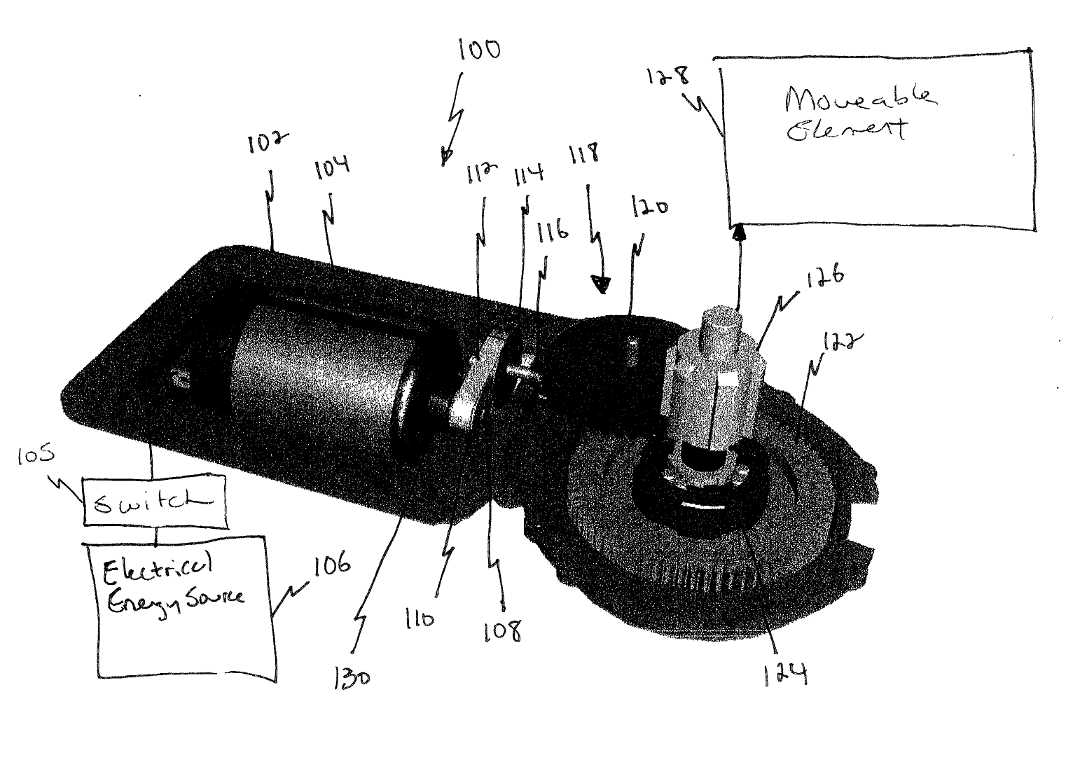

FIG. 1 illustrates an exemplary actuator 100 consistent with the invention. In the illustrated exemplary embodiment, the actuator 100 includes a bottom housing portion 102 for receiving the actuator components. A top housing portion (not shown) mates with the bottom housing portion 102 to enclose the actuator components with an actuator output shaft 126 extending therethrough for driving a movable element. Those skilled in the art will recognize that a wide variety of movable elements may be coupled to the output shaft 126 for causing linear or rotational movement of therein. Also, the actuator components, e.g. motor, gear train, output shaft configuration, etc., may be provided in a variety of configurations depending on the application. It is to be understood, therefore, that the illustrated embodiment is provided only by way of illustration, not of limitation.

As shown, the bottom housing portion 102 receives a motor 104, e.g. a DC electric motor. The motor may be energized by an electrical energy source 106 such as a vehicle battery by selective positioning of a switch 105 positioned inside a vehicle passenger compartment, for example. In the illustrated exemplary embodiment, an output shaft 108 of the motor 104 drives a first belt gear 110, which is coupled to a second belt gear 114 via a drive belt 112. A variety of drive belt configurations will be known to those skilled in the art. For example, the drive belt may be an endless elastomeric band sized to extend over the first and second belt gears with a tight fit.

In the illustrated exemplary embodiment, the second belt gear 114 includes a drive gear 116 coupled thereto for driving an actuator gear train 118. Of course, the configuration of the drive gear 116 and the gear train 118 may vary depending upon the application. In the illustrated embodiment the gear train 118 includes an intermediate compound face gear 120 in meshing engagement with the gear 116 and an output spur gear 122. The output gear 122 drives the actuator output shaft 126, e.g. through a clutch 124. The output shaft 126 is coupled to a moveable element 128, which, in an automotive application, may include a window lift, an adjustable pedal system, a sunroof, car seat, windshield wipers, etc.

Advantageously, the drive belt 112 translates output torque from the motor to the gear train 118 with efficiency similar to that of high efficiency spur gear set, without the audible noise associated with meshing engagement of spur gears. In addition, the drive belt 112 allows flexibility in the center-to-center distance between the belt gear 114 and the output shaft 108 of the motor. For example, where some manufacturing variation exist in the distance between housing features for receiving the motor and the belt gear 114, the drive belt may elastically deform, i.e. stretch, to the accommodate the actual distance between the motor and the belt gear 114. The drive belt 112 thus not only allows for reduced audible noise, but also allows for manufacturing tolerances in the actuator components.

Moreover, a drive belt 112 may be advantageously used in conjunction with elastomeric motor supports 130. Motor supports 130 may be provided at one or more locations between the motor 104 and the housing 102 for mechanically isolating the motor from the housing, thereby reducing audible noise associated with motor vibration. The supports may have an effective spring constant and damping constant, both of which may be varied depending on the type of material and geometry chosen for the support to achieve desired noise performance.

In an actuator consistent with the invention wherein a drive belt 112 is used in conjunction with elastomeric motor supports 130, motor vibration is dampened by the supports and also by elastic deformation of the drive belt between the first and second drive belt gears. The drive belt thus acts as a further vibration/noise dampening mechanism while maintaining efficient transfer of torque from the motor 104 to the gear train 118. In addition, elastic deformation of the drive belt allows for variation in the center-to-center distance between the first and second drive belts resulting from manufacturing variation in the dimensions of the supports 130.

There is thus provided an electromechanical actuator including a drive belt for driving a gear train. The drive belt provides high efficiency transfer of torque from a motor to a gear train without the audible noise generated by conventional spur gear sets, and allows for manufacturing variation in actuator components. The drive belt further provides motor vibration dampening and enables use of elastomeric motor supports for reducing motor vibration and associated noise. Again, it is to be understood that the embodiments that have been described herein are but some of the several which utilize this invention and are set forth here by way of illustration, but not of limitation. It is obvious that many other embodiments, which will be readily apparent to those skilled in the art, may be made without departing materially from the spirit and scope of the invention as defined in the appended claims.

What is claimed is:

1. An electromechanical actuator comprising:
a motor for driving an actuator output shaft through a gear train; and
a drive belt for coupling torque from said motor to said gear train.

2. An actuator according to claim 1, said actuator further comprising a first belt gear directly coupled to an output shaft of said motor and a second belt gear, and wherein said drive belt extends between said first and second belt gears.

3. An actuator according to claim 1, wherein said drive belt comprises an elastomeric material.

4. An actuator according to claim 1, said actuator further comprising a housing and at least one elastomeric motor support disposed between said motor and said housing.

5. An electromechanical actuator comprising:
a housing;
a motor disposed in said housing for driving an output shaft through a gear train;
at least one elastomeric motor support disposed between said motor and said housing;
a first belt gear coupled directly to an output shaft of said motor; and
an elastomeric drive belt extending between said first belt gear and a second belt gear, said second belt gear being coupled to said gear train.

6. A method of dampening motor vibration and noise in an electromechanical actuator, said method comprising:
providing a drive belt for transferring torque from said motor to a gear train coupled to an output shaft of said actuator; and
providing at least one elastomeric motor support between said motor and a housing of said actuator.

7. A method according to claim 6, wherein said drive belt comprises elastomeric material.

8. A method according to claim 6, wherein said actuator comprises a first belt gear coupled directly to an output shaft of said motor and a second belt gear coupled to said gear train, and wherein said drive belt extends between said first and second belt gears.
